(19) United States
(12) Patent Application Publication
(10) Pub. No.: US 2017/0229042 A1
(43) Pub. Date: Aug. 10, 2017

(54) MOBILE ANIMATION TOOL FOR STUDENT-GENERATED MODELS OF CHEMICAL PHENOMENA

(71) Applicant: JULIA ENGLISH WINTER, BLOOMFIELD HILLS, MI (US)

(72) Inventor: JULIA ENGLISH WINTER, BLOOMFIELD HILLS, MI (US)

(21) Appl. No.: 15/428,661

(22) Filed: Feb. 9, 2017

Related U.S. Application Data
(60) Provisional application No. 62/292,996, filed on Feb. 9, 2016.

(51) Int. Cl. G09B 23/24; G06T 13/80; G09B 19/00; G06F 3/0482; G09B 5/02; G09B 9/00; G06F 3/0484; G06F 3/0488

(52) U.S. Cl. CPC G09B 23/24; G06F 3/04845; G06T 13/80; G06F 3/04883; G06F 3/0482; G09B 5/02; G09B 9/00; G09B 19/00; G06T 2200/24

(57) ABSTRACT

An electronic device for creating animations of molecular motions includes a display and a computer processor. The computer processor is configured to present to a user a video frame editor on the display. The video frame editor presents the user with atom and bond selections to be placed on a plurality of video frames. A first input is received from the user for a first set of atoms and bonds to be placed on a first video design frame at a first set of positions. A second input is received from the user for a second video design frame. The second input includes repositioning the first set of atoms and bonds to a second set of positions on the second video design frame. An animation is played in which the first set of atoms and bonds move from the first set of positions to the second set of positions.

### CROSS-REFERENCE TO RELATED APPLICATION

This application claims the benefit of U.S. provisional application Ser. No. 62/292,996 filed Feb. 9, 2016, the disclosure of which is hereby incorporated in its entirety by reference herein.

### TECHNICAL FIELD

The present invention is related to computer processor applications for creating animations of chemical phenomena, and in particular, to applications for animating molecular and atomic motion.

### BACKGROUND

Innovation in science and engineering is critical for the nation's global competitiveness and as a driver for economic growth (National Academy of Sciences, 2010). Yet, fewer than 40 percent of college-bound students achieved the college ready benchmark in science (ACT, 2015). With chemistry named ‘the central science,’ for the bridge it serves between life sciences and physical sciences, the importance of students in gaining a deep, conceptual understanding of chemistry cannot be underestimated.

It can be difficult to foster this type of meaningful learning. Chemistry students can be adept at algorithmic problem-solving with very little understanding of the molecular concepts underpinning those calculations (Nyachwaya, Warfa, Roehrig & Schneider, 2013) The need to ‘get to the right answer’ often overrides the teaching of a conceptual understanding in chemistry. Once a problem is presented which does not fit with the memorized algorithms, a student who relies on these algorithms does not have the conceptual resources to put disparate ideas together. This tendency toward procedural problem-solving in chemistry affects students at all levels of chemical education, from high school to college, and even into graduate levels (Bodner, 1991).

To address these shortcomings, the Next Generation Science Standards (NGSS) recommends that molecular-level explanations for concepts should be presented to students as early as middle school (NGSS, 2013). The call for these reforms has also been applied to chemistry instruction at the university level (Cooper et al., 2015). Teachers and instructors need tools to provide students with molecular representations of phenomena and to assess students' understanding of the phenomena at the molecular level. The research team proposes to create a program that aids teachers both in instruction and evaluation in order to meet these calls for reform.

One way to assess students' levels of conceptual understanding is by requiring them to draw simple particle diagrams to represent various phenomena, as the College Board has recently done in its Advanced Placement (AP) Chemistry exam. The problem is that these diagrams are static. For students to grasp the principles of chemistry—molecular transformations, intermolecular forces, gas laws—they need to understand movement of the particles, for which animations are better-suited than static images (Höffler & Leutner, 2007). Chemistry teachers have been using stop-motion video projects to allow students to create transformations and interactions of electrons and molecules (Nielsen & Hoban, 2015). These video projects require staging and external media, such as clay, construction paper, or white board drawings. These projects also take a good deal of time to create and produce.

Accordingly, there is a need for advanced computer applications for creating animation of molecular phenomena.

### SUMMARY

The present invention solves one or more problems of the prior art by providing, in at least one embodiment, an electronic device for creating animations of molecular motions. The electronic device includes a display and a computer processor. The computer processor is configured to present to a user a video frame editor on the display. The video frame editor presents the user with atom and bond selections to be placed on a plurality of video frames. A first input is received from the user for a first set of atoms and bonds to be placed on a first video design frame at a first set of positions. A second input is received from the user for a second video design frame. The second input includes repositioning the first set of atoms and bonds to a second set of positions on the second video design frame. An animation is played in which the first set of atoms and bonds move from the first set of positions to the second set of positions by sequentially displaying the first video design frame at a first display time, a plurality of intermediate video frames at intermediate display times, and the second video design frame at a second display time that is after the first display time. The intermediate display times are between the first display time and the second display time. Characteristically, the plurality of intermediate video frames is generated by the computer processor to show sequential partial movement from the first set of positions to the second set of positions.

In another embodiment, a non-transitory computer-readable medium that includes instructions for a stereochemistry game application is provided. The instructions, when executed by a computer processor, perform operations that present a user with a video frame editor on a display. The video frame editor presents the user with atom and bond selections to be placed on a plurality of video frames. The executed instructions also include operations that receive a first input from the user for a first set of atoms and bonds to be placed on a first video design frame at a first set of positions and receive second input from the user for a second video design frame. The second input includes repositioning the first set of atoms and bonds to a second set of positions on the second video design frame. The executed instructions also include operations that play an animation in which the first set of atoms and bonds move smoothly from the first set of positions to the second set of positions by sequentially displaying the first video design frame at a first time, a plurality of intermediate video frames at intermediate times, and the second video design frame at a second time that is after the first time. The intermediate times are between the first time and the second time. Characteristically, the plurality of intermediate video frames is generated by the computer processor to show sequential partial movement from the first set of positions to the second set of positions.

### BRIEF DESCRIPTION OF THE DRAWINGS

FIG. 1 is a schematic illustration of an electronic device implementing a molecular animation tool;

FIG. 2 is a schematic illustration of a video frame editor;

FIG. 3 is a schematic illustration of a video frame editor showing a pop up window for a user defined atom selection;

FIG. 4 is a schematic illustration of an interface window for loading and saving animations; and

FIGS. 5A and 5B provide a schematic flowchart showing the operation of the molecular animation tool.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein some features may be exaggerated or minimized to show details of particular components. Therefore, specific structural and functional details disclosed herein are not to be interpreted as limiting, but merely as a representative basis for teaching one skilled in the art to variously employ the present invention.

The term “graphical control element” refers to graphical items presented to a user for receiving data or initiating associated operations. Examples of graphical control elements include, but are not limited to, buttons, menu items, scroll bars, slider, and the like.

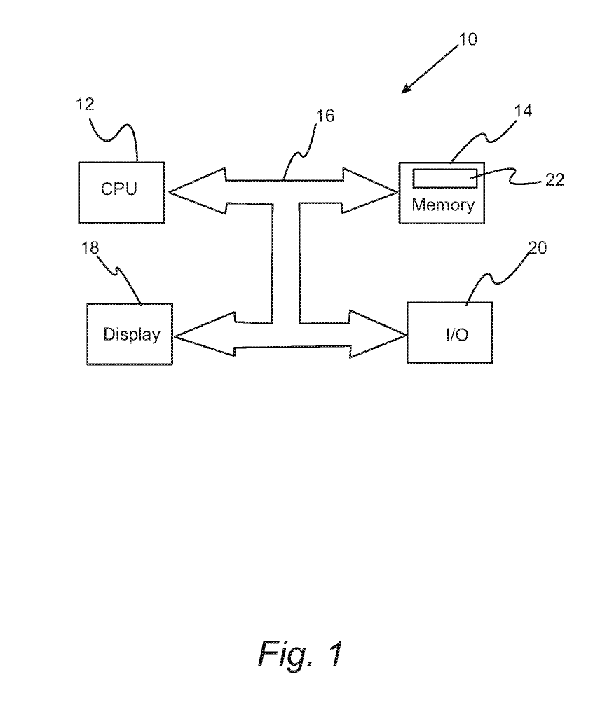

With reference to FIG. 1, a schematic illustration of an electronic device implementing a molecular animation tool is provided. Electronic device 10 includes computer processor 12 that executes the instructions for the game. It should be appreciated that virtually any type of computer processor may be used, including microprocessors, multicore processors, and the like. The instructions for the molecular animation tool typically are stored in computer memory 14 and accessed by computer processor 12 via connection system 16. In a variation, connection system 16 includes a data bus. In a refinement, computer memory 14 includes a computer-readable medium which can be any non-transitory (e. g., tangible) medium that participates in providing data that may be read by a computer. Specific examples for computer memory 14 include, but are not limited to, random access memory (RAM), read only memory (ROM), hard drives, optical drives, removable media (e.g. compact disks (CDs), DVD, flash drives, memory cards, etc.), and the like, and combinations thereof. In another refinement, computer processor 12 receives instructions from computer memory 14 and executes these instructions, thereby performing one or more processes, including one or more of the processes described herein. Computer-executable instructions may be compiled or interpreted from computer programs created using a variety of programming languages and/or technologies including, without limitation, and either alone or in combination, Java, C, C++, C#, Fortran, Pascal, Visual Basic, Java Script, Perl, PL/SQL, etc. Display 18 is also in communication with computer processor 12 via connection system 16. Electronic device 10 also optionally includes various in/out ports 20 through which data from a pointing device may be accessed by computer processor 12. Examples for the electronic devices include, but are not limited to, desktop computers, smart phones, tablets, or tablet computers. Examples of pointing devices include a mouse, touch pad, trackball, and a user's finger when the display is a touch screen.

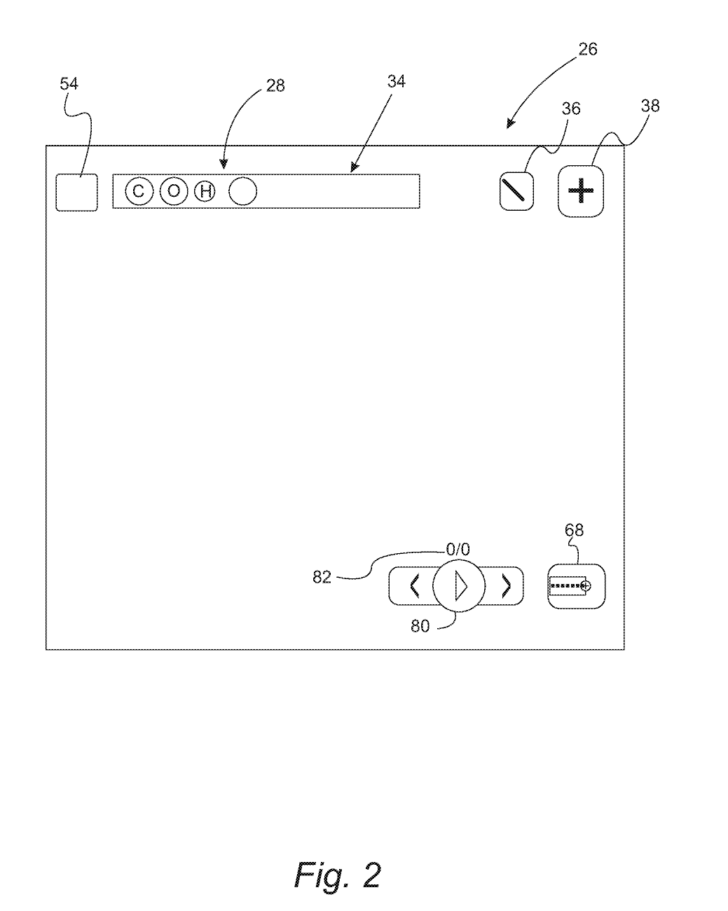

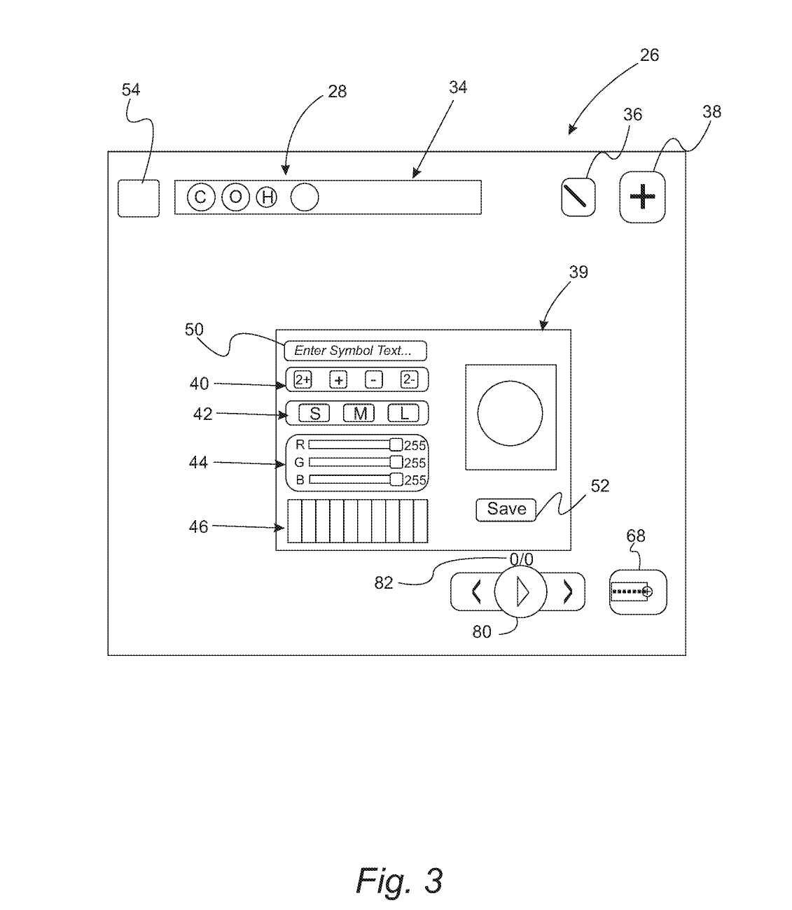

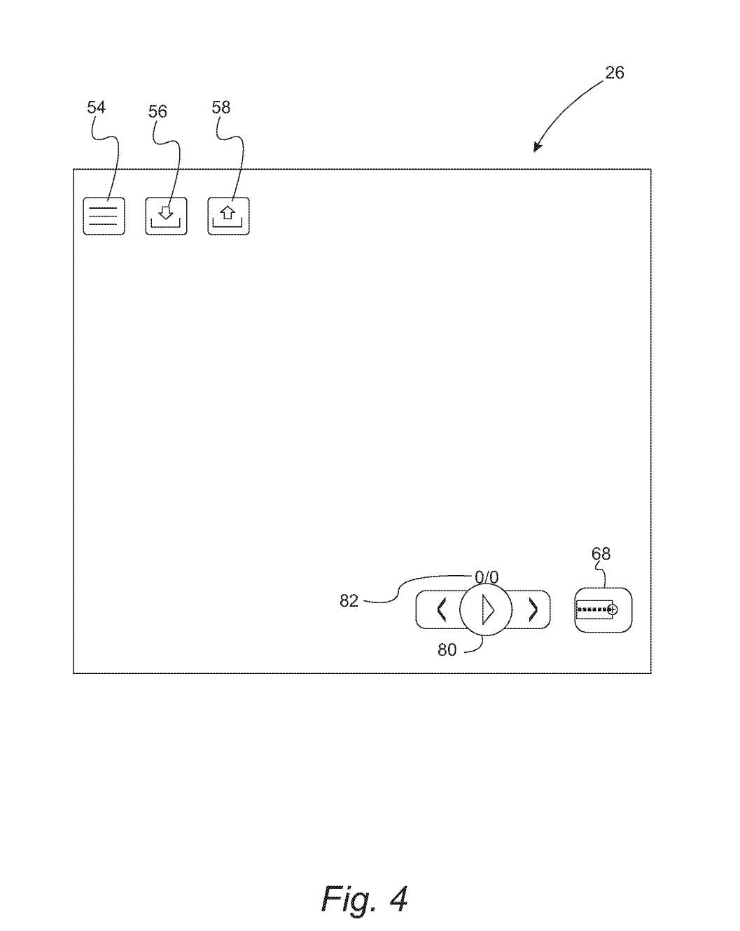

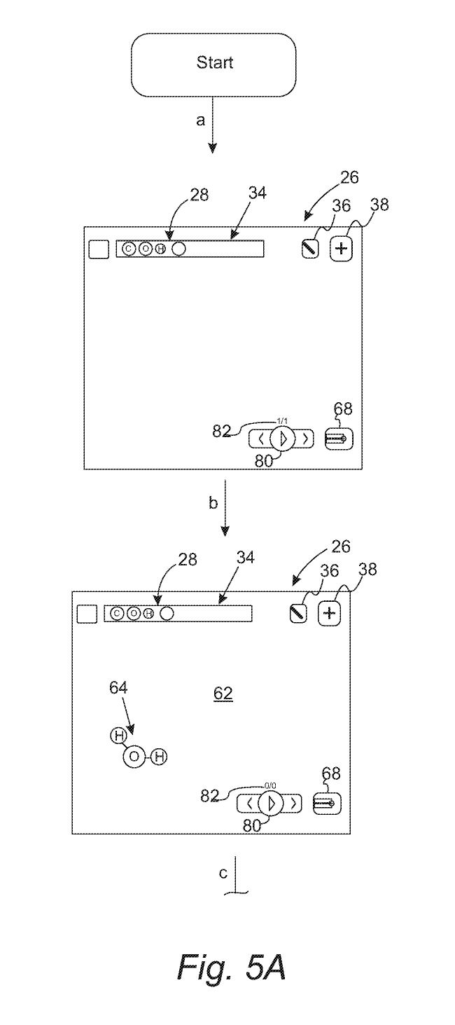

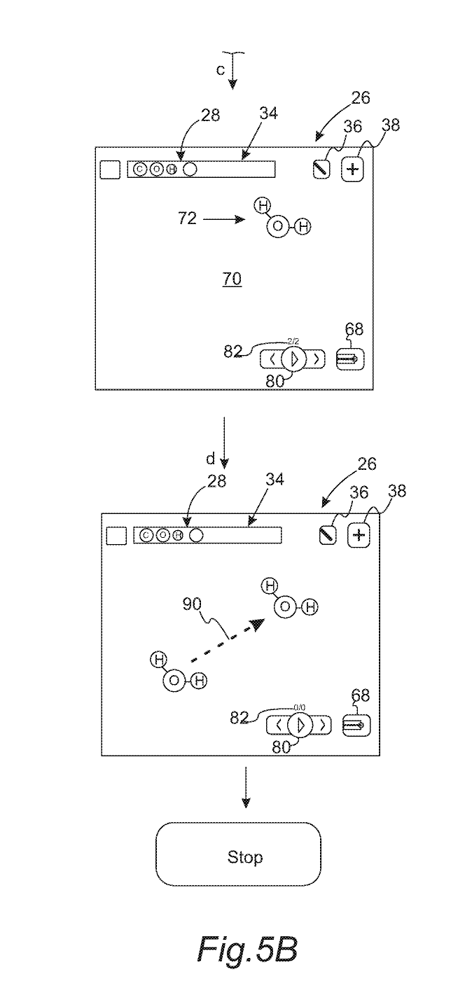

With reference to FIGS. 1, 2, 3, 4, 5A and 5B, operation of electronic device 10 for the cyclohexane stereochemistry is described. FIG. 2 is a schematic illustration of a video frame editor. FIG. 3 is a schematic illustration of a video frame editor showing a pop up window for a user defined atom selection. FIG. 4 is a schematic illustration of an interface window for loading and saving animations. FIGS. 5A and 5B provide a schematic flowchart showing the operation of the molecular animation tool. The computer processor 12 is configured to present to a user in step a) a video frame editor 26 on the display 18. Video frame editor 26 presents the user with atom and bond selections to be placed on a plurality of video frames. These selections can be made by the user pressing a graphical control element (e.g., button or a menu item) to select the atom or bond to be placed in drawing region 30 of the frame editor. Video frame editor 26 includes a drawing region 30 which represents a video frame to be displayed during animation. The video frame editor also displays several user selectable atom selections 32 in atom selection area 34. The video frame editor also displays bond selection graphical control element 36. For these selections, an icon is displayed that can be clicked on (i.e., actuated) by the user. The figure frame editor also displays an atom add selection 38 for adding user defined atoms to the atom selection area 34. When graphical control element 38 is actuated, a window 39 is displayed that allows creation of a selectable atom to be placed in atom selection area 34. The user is able to adjust the size of the atom with items 40, 42 and the color with items 44, 46. A label for the atom is entered in text field 50. The user defined atom is added to the atom selection area 34 by actuating add save graphical control element 52. Actuation of graphical control element 54 displays a load or save window where graphical control element 56 allows a previously created animation to be loaded and graphical control element 58 allows an animation to be saved.

In step b), a first input is received from the user for a first set of atoms and bonds to be placed on a first video design frame 62 at a first set of positions 64. This first input is created by the user selecting the desired atoms and bond using the interface set forth above. The user can selected the atoms and bond using a pointing device and move them as desired within drawing region 30. Atoms and bonds can be removed by the user selecting them with a pointing device and then entering the “delete” key on a keyboard or selecting “delete” from a menu (e.g., a pop up menu). When the first video design frame is completed, the user initiates a frame addition command by selecting frame addition graphical control element 68 which sets the first video frame.

At this point, the user can make changes that are to be present in second design frame 70. In step c), a second input is received from the user for a second video design frame 70. The second input includes repositioning the first set of atoms and bonds to a second set of positions 72 on the second video design frame 70.

In step d), an animation is played by the user selecting play graphical control element 80. Text graphic 82 identifies the video design frame currently being displayed over the total number of video design frames. During the animation, the first set of atoms and bonds moves from the first set of positions 64 to the second set of positions 72 by sequentially displaying the first video design frame at a first display time, a plurality of intermediate video frames at intermediate display times, and the second video design frame at a second display time that is after the first display time. The intermediate display times are between the first display time and the second display time. Characteristically, the plurality of intermediate video frames is generated by the computer processor to show sequential partial movement from the first set of positions to the second set of positions. To this end, positions of the atoms and bonds in the intermediate frames are estimated by interpolation, and in particular, a linear interpolation. Imaginary line 90 shows the path along which the atoms move.

Typically, the computer processer is further configured to receive additional inputs from the user for additional video design frames, the additional inputs including repositioning of atoms and/or bonds. As set forth above, these additional inputs can include addition or removal of atoms or bonds. Therefore, the computer processor is further configured to play the animation by sequentially further displaying of the additional video design frames and a plurality of additional intermediate video frames, the intermediate video frames arranged to be displayed at additional intermediate display times between temporally video design frames. As set forth above, the plurality of intermediate additional video frames are generated by the computer processor to show sequential partial movement between positions displayed in temporally adjacent additional video design frames.

Moreover, computer processor is further configured to play the animation by sequentially displaying the additional video design frames with bond and atom movement being smoothly displayed.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electronic device for producing animations of atom and molecular bond formation and movement:
a display; and
a computer processor configured to:
present to a user a video frame editor on the display, the video frame editor presenting the user with atom and bond selections to be placed on a plurality of video frames;
receive a first input from the user for a first set of atoms and bonds to be placed on a first video design frame at a first set of positions;
receive second input from the user for a second video design frame, the second input including repositioning the first set of atoms and bonds to a second set of positions on the second video design frame; and
play an animation in which the first set of atoms and bonds move from the first set of positions to the second set of positions by sequentially displaying the first video design frame at a first display time, a plurality of intermediate video frames at intermediate display times, and the second video design frame at a second display time that is after the first display time, the intermediate display times being between the first display time and the second display time, wherein the plurality of intermediate video frames are generated by the computer processor to show sequential partial movement from the first set of positions to the second set of positions.

2. The electronic device of claim 1 wherein the second input includes addition or removal of atoms or bonds.

3. The electronic device of claim 1 wherein the computer processer is further configured to receive additional inputs from the user for additional video design frames, the additional inputs including repositioning of atoms and/or bonds.

4. The electronic device of claim 3 wherein the additional input includes addition or removal of atoms or bonds.

5. The electronic device of claim 4 wherein the computer processor is further configured to play the animation by sequentially further displaying of the additional video design frames and a plurality of additional intermediate video frames, the intermediate video frames arranged to be displayed at additional intermediate display times between temporally video design frames.

6. The electronic device of claim 5 wherein the plurality of intermediate additional video frames are generated by the computer processor to show sequential partial movement between positions displayed in temporally adjacent additional video design frames.

7. The electronic device of claim 5 wherein the computer processor is further configured to play the animation by sequentially displaying the additional video design frames with bond and atom movement being smoothly displayed.

8. The electronic device of claim 1 wherein the display is a touch screen display by which the user creates the first input using touch screen operations to draw the first input.

9. The electronic device of claim 1 further comprising a pointing device with which the user creates the first input.

10. The electronic device of claim 1 wherein the electronic device is a desktop computer, a smart phone, a tablet, or a tablet computer.

11. A non-transitory computer-readable medium comprising instructions for producing animations of atom and molecular bond formation and movement that, when executed by a computer processor, perform operations to:
present to a user a video frame editor on a display, the video frame editor presenting the user with atom and bond selections to be placed on a plurality of video frames;
receive a first input from the user for a first set of atoms and bonds to be placed on a first video design frame at a first set of positions;
receive second input from the user for a second video design frame, the second input including repositioning the first set of atoms and bonds to a second set of positions on the second video design frame; and
play an animation in which the first set of atoms and bonds move smoothly from the first set of positions to the second set of positions by sequentially displaying the first video design frame at a first time, a plurality of intermediate video frames at intermediate times, and the second video design frame at a second time that is after the first time, the intermediate times being between the first time and the second time
wherein the plurality of intermediate video frames are generated by the computer processor to show sequential partial movement from the first set of positions to the second set of positions.

12. The non-transitory computer-readable medium of claim 11 wherein the second input includes addition or removal of atoms or bonds.

13. The non-transitory computer-readable medium of claim 11 wherein the computer processer further performs an operation of receiving additional inputs from the user for additional video design frames, the additional inputs including repositioning of atoms and/or bonds.

14. The non-transitory computer-readable medium of claim 13 wherein the additional inputs each independently include addition or removal of atoms or bonds.

15. The non-transitory computer-readable medium of claim 13 wherein the computer processor further performs an operation of playing the animation by sequentially further displaying of the additional video design frames and a plurality of additional intermediate video frames, the intermediate video frames arranged to be displayed at additional intermediate display times between temporally video design frames.

16. The non-transitory computer-readable medium of claim 15 wherein the plurality of intermediate additional video frames are generated by the computer processor to show sequential partial movement between positions displayed in temporally adjacent additional video design frames.

17. The non-transitory computer-readable medium of claim 15 wherein the computer processor further performs an operation of playing the animation by sequentially displaying the additional video design frames with bond and atom movement being smoothly displayed.

18. The non-transitory computer-readable medium of claim 11 wherein the display is a touch screen display by which the user creates the first input using touch screen operations to draw the first input.

19. The non-transitory computer-readable medium of claim 11 wherein the computer process is operable to receive the first input and the second input from a pointing device.

20. The non-transitory computer-readable medium of claim 11 wherein a desktop computer, a smart phone, a tablet, or a tablet computer includes the computer processor.
